(19) United States
(12) Patent Application Publication
(10) Pub. No.: US 2005/0129411 A1
(43) Pub. Date: Jun. 16, 2005

(54) Apparatus and method for optimizing bias voltage of electro-optic modulator and optical transmitting system using the same

(76) Inventors: Hyunwoo Cho, Seoul (KR); Sang-Soo Lee, Daejon (KR); Sang-Kyu Lim, Daejon (KR); Jyung-Chan Lee, Daejon (KR); Seung-Il Myong, Daejon (KR); Je-Soo Ko, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/876,436

(22) Filed: Jun. 24, 2004

(30) Foreign Application Priority Data
Dec. 11, 2003 (KR) 2003-90267

(51) Int. Cl. G02F 1/01; G02F 1/035; H04B 10/00

(52) U.S. Cl. 398/155

(57) ABSTRACT

Provided are an apparatus for optimizing bias voltage of an electro-optic modulator, a method therefor, and an optical transmission system using the method. The present research provides a bias voltage optimizing apparatus of an electro-optic modulator that can stabilize bias voltage supplied to the electro-optic modulator through automatic bias voltage initialization control by considering the point that the form of an optical output signal and the intensity of a clock component are changed according to the bias voltage of the electro-optic modulator, a method therefor and an optical transmission system using the method. The apparatus includes: a clock extracting unit for extracting a clock frequency component from the frequency components in a wideband spectrum of the electro-optic modulator; a control unit for finding a point of the lowest electric intensity by detecting an electric intensity of the extracted frequency component and controlling the bias voltage adaptively by changing the bias voltage; and a bias voltage adjusting unit for controlling the bias voltage of the electro-optic modulator under the control of the bias voltage controlling unit.

### FIELD OF THE INVENTION

The present invention relates to an electro-optic communication technology; and, more particularly, to an apparatus and a method for optimizing bias voltage of a modulator of an optical transmitter in an optical communication system.

### DESCRIPTION OF RELATED ART

An optical transmitter is an apparatus for converting input electric signals into optical signals by utilizing an electro-optic modulator. The characteristics of output optical signals are changed according to the bias voltage of input electric signals. Since the change in the characteristics of the output optical signals affects the performance of the entire optical communication system, it is very important to optimize the bias voltage.

An electro-optic modulator has a characteristic of transferring an output optical signal with respect to an input electric signal. So, it performs the function of modulating electric signals into optical signals and outputs the optical signals. Also, the bias voltage of the input electric signal can be controlled by applying DC voltage to a Direct Current (DC) electrode installed in the electro-optic modulator. However, if the bias voltage is not controlled properly, the corresponding output optical signal is distorted, and thus it degrades the overall performance of the optical communication system.

Technology for stabilizing an electro-optic modulator is proposed in U.S. Pat. No. 6,046,838 issued on Apr. 4, 2000, entitled “Automatic bias control for electro-optic modulators,” which will be referred to as a first prior art. The first prior art suggests generating and detecting a pilot signal and using the pilot signal to control the bias voltage of the electro-optic modulator. However, since the constitutional elements for controlling the bias voltage of the electro-optic modulator are all analog circuits and generation through detection of the pilot signal is formed in complicated circuits, electric noise generated additionally due to the formation of the circuits can be included. So, it becomes necessary to form an additional circuit to get rid of the noise. In addition, once the pilot signal is supplied to the electro-optic modulator, the pilot signal can be added to a data signal and perform as noise in an optically modulated signal.

Meanwhile, technology related to the optimum extinction ratio (ER) of an electro-optic modulator is disclosed in U.S. Pat. No. 6,178,032 issued on Jan. 23, 2001, entitled “Intensity modulator with optimum extinction ratio of an output optic pulse,” which will be referred to as a second prior art herein. According to the second prior art, a bias voltage is controlled to be stabilized by comparing the optical intensity of an optically modulated output signal with a signal from an RF pulse generator. However, the technology has a problem that the output is limited to the optical signal having a pulse form because the input electric signal of the modulator is in the form of a pulse.

In the meantime, a conventional method for optimizing bias voltage in an electro-optic modulator is to detect bias voltage at the highest optical power and bias voltage at the lowest optical power by varying the level of bias voltage sequentially at a predetermined interval and measuring power of an optical output signal at each variation, and then to set up the mean level as the optimum bias voltage. However, this method takes long time for initialization, since it should go through the process of detecting the bias voltage levels where the optical power is the highest and the lowest.

### SUMMARY OF THE INVENTION

It is, therefore, an object of the present invention to provide a bias voltage optimizing apparatus of an electro-optic modulator that can optimize and stabilize bias voltage applied to the electro-optic modulator through automatic bias control by considering the point that the eye diagram of an optical output signal and the intensity of a clock component are changed according to the bias voltage, a method therefor and an optical transmitting system using the method.

In accordance with an aspect of the present invention, there is provided an apparatus for optimizing bias voltage of an electro-optic modulator in an optical transmitting system, including: a clock extracting unit for extracting a clock frequency component from various frequency components in an output spectrum of the electro-optic modulator; a control unit for searching a point that the extracted clock component has the lowest electric intensity and controlling the bias voltage adaptively in case that the optimum point is drifted according as the environmental condition has variation; and a bias voltage adjusting unit for changing the bias voltage of the electro-optic modulator under the control of the control unit.

In accordance with another aspect of the present invention, there is provided an optical transmitting system for converting an input electric signal into an optical signal in an electro-optic modulator and outputting the optical signal, including: a light source for providing an optical signal of a predetermined intensity to the electro-optic modulator; an electric amplifier for amplifying the input electric signal and providing the amplified electric signal to the electro-optic modulator; the electro-optic modulator for converting the electric signal into the optical signal and outputting the optical signal; a clock extracting unit for extracting a clock frequency component from various frequency components in an output spectrum of the electro-optic modulator; a control unit for searching a point that the extracted clock frequency component has the lowest electric intensity and adaptively controlling the bias voltage so that the electric intensity of a currently extracted clock component always has the lowest electric intensity regardless of an environmental variation; and a bias voltage adjusting unit for adjusting the bias voltage of the electro-optic modulator under the control of the control unit.

In accordance with another aspect of the present invention, there is provided a method for optimizing bias voltage of an electro-optic modulator in an optical transmitting system, including the steps of: a) extracting a clock frequency component from various frequency components in an output spectrum of the electro-optic modulator by supplying an arbitrary level of bias voltage to the electro-optic modulator; b) finding out the direction the bias voltage is moved so that the intensity of the extracted clock is lower; c)comparing the electric intensity of a clock frequency component at the bias voltage lower or higher than a previous bias voltage with the old value stored already; d) storing electric intensity of currently detected clock frequency component if and only if it is lower than that of the previously stored clock frequency component; e) repeating steps b) to c) until the lowest clock intensity is stored and determining an optimum bias point with the lowest electric intensity of a clock frequency component; and f) adjusting the bias voltage of the electro-optic modulator to the optimum bias voltage when a transfer function is drifted due to a change in an environmental condition such as temperature during the operation of optical transmitter.

The technology of the present invention controls the bias voltage supplied to the electro-optic modulator adaptively by using the fact that the optimum output characteristics appear when an electric intensity of a clock frequency component in an output signal is lowest according as the bias voltage is changed step by step. In other words, it utilizes the phenomenon that the clock frequency component of an output modulated signal is changed according to the bias voltage, and the optimum output characteristics appear at the lowest electric intensity of the clock frequency component in the output signal.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a bias voltage optimizing apparatus of an electro-optic modulator and an optical transmitting system in accordance with an embodiment of the present invention;

FIG. 2 is a block diagram describing a clock-extracting unit of FIG. 1 in accordance with an embodiment of the present invention;

FIGS. 3A to 3E are eye diagrams showing a phenomenon the cross point is changed according to varying bias voltage of the electro-optic modulator in accordance with an embodiment of the present invention;

FIGS. 4A to 4E are electrical spectra showing corresponding frequency characteristics of the output optical signals of FIGS. 3A to 3E;

FIG. 5 is a graph showing the change in a transfer curve of the electro-optic modulator due to an environmental variation such as temperature used in the present invention; and

FIG. 6 is a flowchart describing a bias voltage control process including the initialization by using the bias voltage optimizing method of the electro-optic modulator and an adaptive stabilization to compensate variation of an environmental condition in accordance with an embodiment of the present invention.

### DETAILED DESCRIPTION OF THE INVENTION

Other objects and aspects of the invention will become apparent from the following description of the embodiments with reference to the accompanying drawings, which is set forth hereinafter.

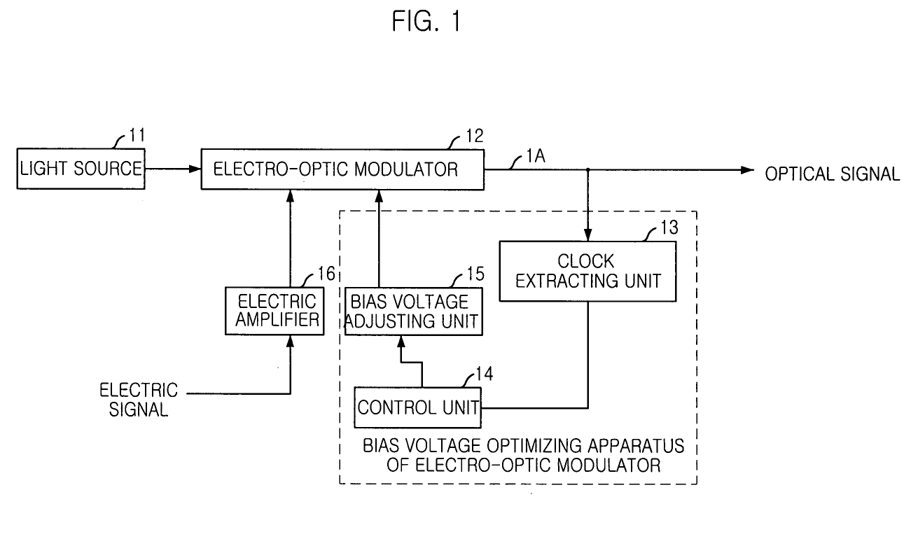

FIG. 1 is a block diagram showing a bias voltage optimizing apparatus of an electro-optic modulator and an optical transmitting system in accordance with an embodiment of the present invention.

The optical transmitter converts input electric signals into optical signals by utilizing the electro-optic modulator and outputs the optical signals. The characteristics of the output optical signals are changed according to the bias voltage of the input electric signals and the change in the characteristics of the output optical signals affects the overall performance of the optical communication system.

The present invention makes use of a phenomenon that the clock frequency component in an electrical spectrum of a signal modulated and outputted according to a bias voltage is changed. Specifically, if the bias voltage is changed, the optimum output characteristics appear on condition that the clock frequency component of the output signal has the lowest electric intensity.

Referring to FIG. 1, the bias voltage optimizing apparatus of the electro-optic modulator of the present invention includes: a clock extracting unit 13, a control unit 14, and a bias voltage control unit 15.

The clock extracting unit 13 extracts a clock frequency component from various frequency components of an output spectrum of an electro-optic modulator 12. The control unit 14 finds out the lowest electric intensity among the electric intensities of the extracted frequencies at each bias point swept in a constant step and controls bias voltage adaptively to maintain the optimum point in manner to changing the bias voltage so that the currently detected electric signal should have the lowest electric intensity. The bias voltage control unit 15 changes the bias voltage so that the variation determined by the control unit 14 is fed back to the electro-optic modulator 12.

The optical transmitting system, to which the bias voltage optimizing apparatus of the electro-optic modulator is applied, includes a light source 11, the electro-optic modulator 12, a clock component extraction unit 13, the control unit 14, a bias voltage control unit, and an electric signal amplifier 16.

The light source 11 provides an optical signal having a uniform intensity to the electro-optic modulator 12. The electro-optic modulator 12 modulates an electric signal into an optical signal. The clock component extraction unit 13 extracts a clock frequency component from various frequency components of the output spectrum in the electro-optic modulator 12. The control unit 14 finds out the lowest electric intensity among the electric intensities of the extracted frequencies at each bias point swept in a constant step and controls bias voltage adaptively in the manner to adjusting the bias voltage so that the currently detected electric signal should have the lowest electric intensity.

The bias voltage adjusting unit 15 controls the bias voltage so that the variation determined by the control unit 14 is fed back to the electro-optic modulator 12.

The electric signal amplifier 16 amplifies the input electric signal and provides the amplified signal to the electro-optic modulator 12.

Hereafter, the operation of the bias voltage optimizing apparatus of the electro-optic modulator and the operation of the optical transmission system using the apparatus will be described more in detail.

The light source outputs a continuous wave (CW) light having a uniform intensity and the CW light is inputted to the electro-optic modulator 12. An electric signal is amplified to amplitude enough to drive the electro-optic modulator 12 in the electric signal amplifier 16 and inputted to a radio frequency (RF) electrode. Then, the input electric signal is converted into an optical signal in the electro-optic modulator 12.

The clock extracting unit 13 converts part of the frequency components in the wideband spectrum of the optical signal outputted from the electro-optic modulator 12 into electric signals by tapping part of an output line 1A of the electro-optic modulator 12, and extracts only clock frequency components from the frequency components of the electric signals obtained from the optical-to-electrical conversion. Then, the control unit 14 controls the bias voltage of the electro-optic modulator 12 by comparing the electric intensities of the frequency.

The control unit 14 detects the electric intensities of the clock frequency components extracted in the clock extracting unit 13, stores the lowest electric intensity, compares the intensity of a currently extracted clock frequency component with the lowest electric intensity at each bias point swept in a constant step, and controls the bias voltage of the electro-optic modulator 12 adaptively to be the lowest electric intensity by utilizing the bias voltage control unit 15. Here, the control unit 14 commands to the bias voltage-adjusting unit 15 to input the changed bias voltage to the DC electrode of the electro-optic modulator 12.

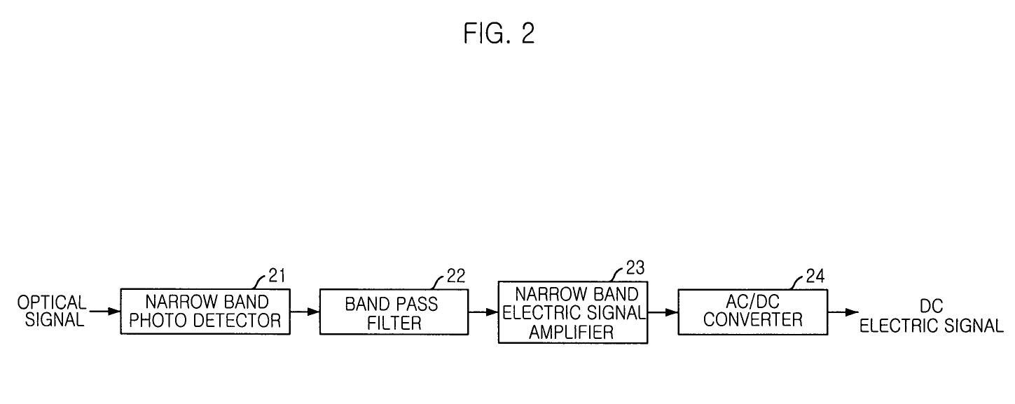

FIG. 2 is a block diagram describing a clock extracting unit of FIG. 1 in accordance with an embodiment of the present invention. The clock extracting unit 13 will be described more in detail with reference to FIG. 2.

To extract the intensity of the clock component of a signal outputted from the electro-optic modulator 12, first, a narrow band photo detector 21 with a neighbor bandwidth centering around a clock frequency as a pass-band converts an optical signal into an electric signal by using some signals in the output line 1A of the electro-optic modulator 12. The optical-to-electrical converted signal passes through a band pass filter 22 that takes the clock frequency as the center frequency and has a high Q-value. This way, only the clock frequency component can be extracted.

Since the extracted clock component may be a very small value, it is amplified to amplitude enough to drive the electro-optic modulator 12 in a narrow band electric signal amplifier 23 whose center frequency is also the clock frequency. Since the signal is an alternating current (AC) clock signal, it is converted into a DC value that goes in proportion to the intensity of the clock frequency component by using an AC/DC converter 24.

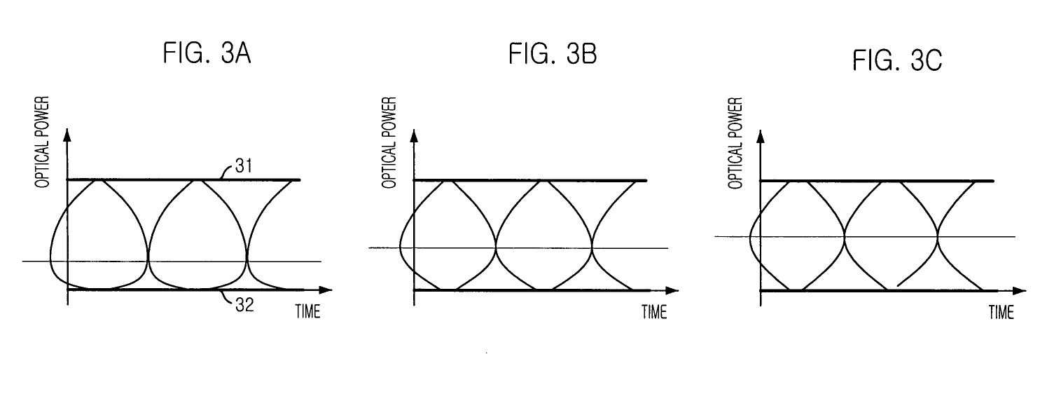

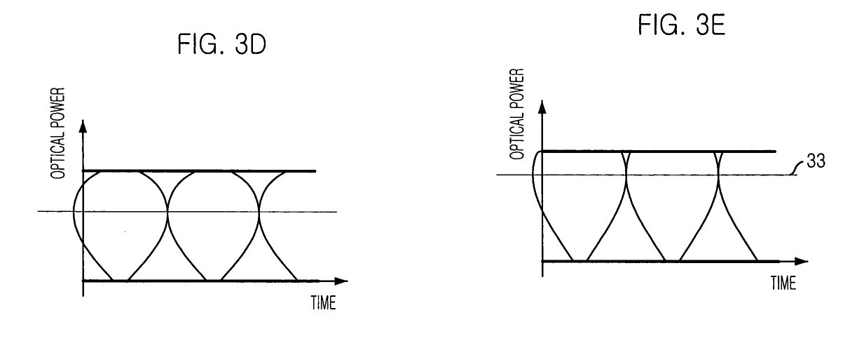

FIGS. 3A to 3E are eye diagrams showing changes of crossing point of the electro-optic modulator 12 according to varying bias voltages in accordance with an embodiment of the present invention.

The crossing points 33 between a 1-level signal 31 and a 0-level signal 32 are changed as shown in FIGS. 3A to 3E sequentially. From the drawings, it can be seen that the eye diagram of FIG. 3C is excellent.

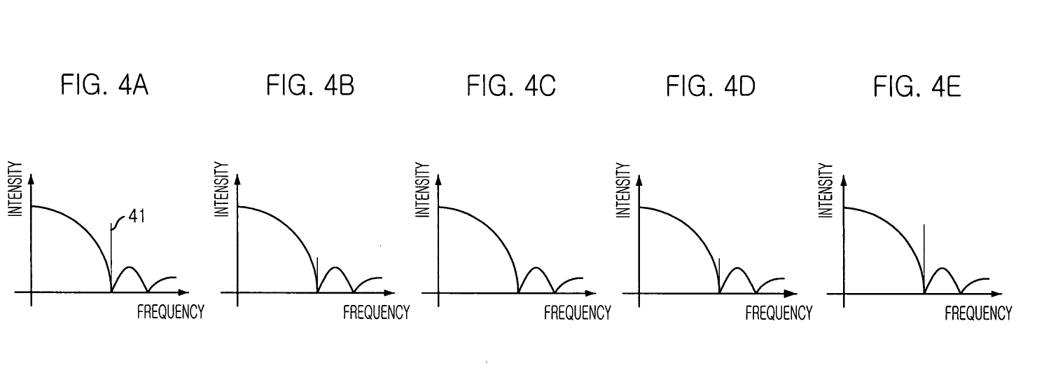

The output optical signals of FIGS. 3A to 3E are converted into the electric signals and presented in the electrical spectra in FIGS. 4A to 4E.

In FIGS. 4A to 4E, the overall frequency distribution has a shape of a Sinc function regardless of changes of the bias voltage but a clock frequency component 41 is changed according to bias voltage. Particularly, if the eye crossing points 33 are higher or lower than the eye crossing point of FIG. 3C, clock frequency components are always increased. Therefore, the optimum bias voltage is a point where a clock frequency component has the lowest electric intensity.

The bias voltage optimizing method of the electro-optic modulator 12 of the present invention makes use of the principles that the output signal of the electro-optic modulator 12 has the variation of the clock frequency intensity on the electrical spectrum shown in FIGS. 4A to 4E based on the conditions of FIGS. 3A to 3E and that in the case of FIG. 3C the best eye opening is presented and corresponding clock frequency has the lowest electric intensity as shown FIG. 4C in the optimum bias voltage.

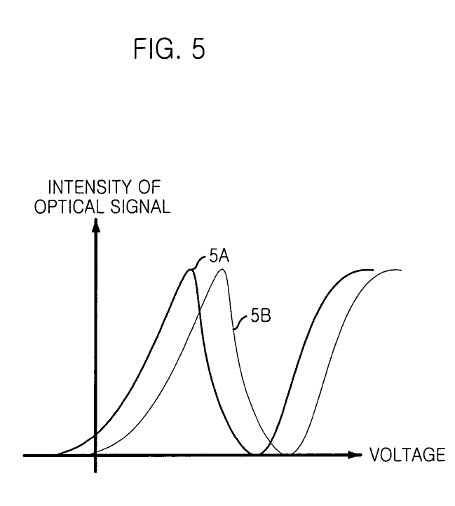

FIG. 5 is a graph showing a change in a transfer curve of the electro-optic modulator used in the present invention. When it is said that the transfer function at the initial temperature is ‘5A,’ the optimum bias voltage is found based on the transfer function. However, if the transfer function is changed into ‘5B’ due to a change in temperature during operation and if the bias voltage is maintained without change, the optimum optical signal is not outputted. Therefore, it is necessary to change the optimum bias voltage adaptively to it. This is called a bias voltage optimizing process of an electro-optic modulator. In short, the initial optimum bias voltage is increased or decreased little by little to find out a direction where the clock component has a lower electric intensity. Then, the bias voltage is moved to the direction to thereby detect a point where the electric intensity of the clock component at the bias voltage becomes the same at the initial optimum bias voltage by moving the bias voltage in the direction.

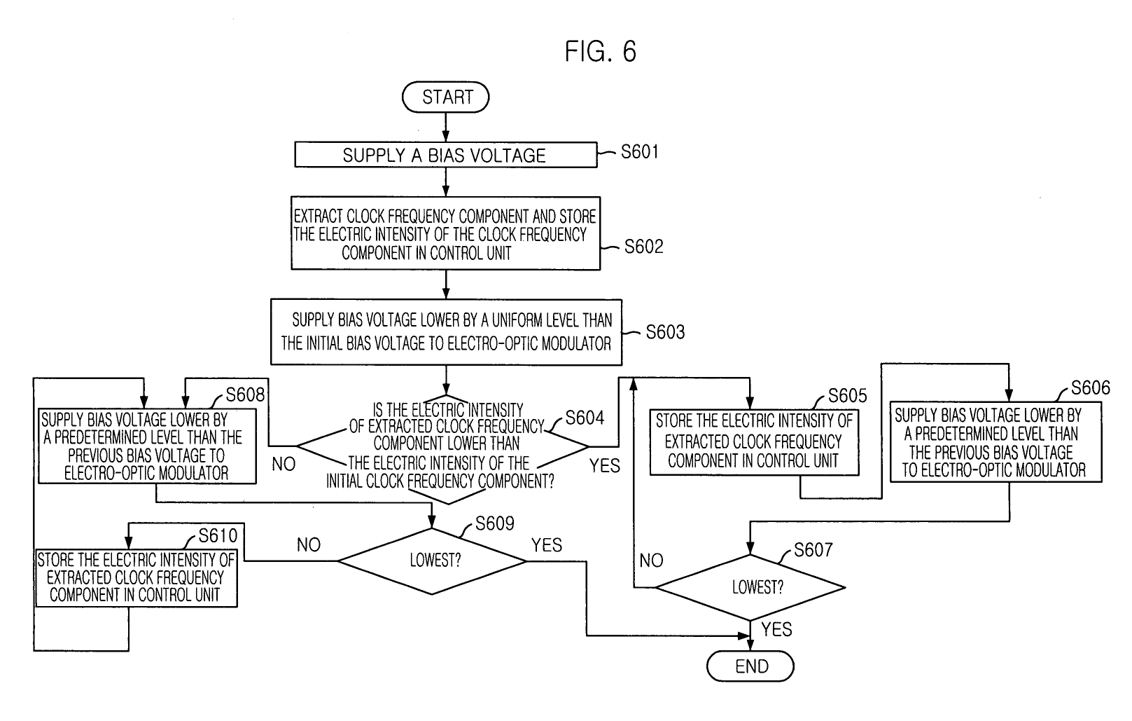

FIG. 6 is a flowchart describing a bias voltage control process including the initialization using the bias voltage optimizing method of the electro-optic modulator and the adaptive stabilization corresponding to environmental variation in accordance with an embodiment of the present invention.

Since the lowest clock intensity appears at the optimum bias voltage, if the lowest optical intensity is found, the bias voltage optimizing process can be finished quicker than a conventional method in which the bias voltage at the mean power value is found. In accordance with the present invention, the initialization process is completed right after the lowest electric intensity is found and the adaptation process with respect to a drift of the transfer function described in FIG. 5.

The bias voltage controlling process including the initialization and the adaptive stabilization will be described herein with reference to FIG. 6. At step S601, the control unit 14 commands the bias voltage-adjusting unit 15 to supply an arbitrary level of bias voltage to the electro-optic modulator 12. At step S602, the clock extracting unit 13 converts optical output signals tapped from the electro-optic modulator 12 into electric signals, extracts clock frequency components from the frequency components of the electric signals, and stores electric intensity of the extracted clock frequency components in the control unit 14.

Subsequently, at step S603, the control unit 14 commands to supply a bias voltage lower than the initial value by a predetermined level to the electro-optic modulator 12 in order to see if decrease of the bias voltage also reduces the electric intensity of the clock frequency component. At step S604, the electric intensity of the extracted clock frequency component is compared with that of the initially stored value.

As a result of the comparison at step S604, if the electric intensity of the currently extracted clock frequency component is lower than that of the initially stored clock frequency component, it is preceding at step S605. That is, it is stored in the control unit 14. Then, at the loop from steps S605 to S607, a bias voltage lower than the previous value by a predetermined level is supplied to the electro-optic modulator 12 again and again until the lowest electric intensity is sought by searching for a lower electric intensity of a clock frequency component.

As a result of the step S604, if the electric intensity of the currently extracted clock frequency component is higher than that of the initially stored clock frequency component, it is preceding at step S608, not S605. That is, the control unit 14 does not store the current value and a bias voltage higher than the initial value by a predetermined level is applied to the electro-optic modulator 12. Then, similarly at the loop from steps S608 to 610, a bias voltage higher than the previous value by a predetermined level is supplied to the electro-optic modulator 12 again an again until the lowest electric intensity is sought by searching for a lower electric intensity of a clock frequency component.

Regardless of the loop from S605 to S607 neither S608 to S610, once the lowest clock intensity is sought, the loop operation is ended. Thus the control unit 14 stores the lowest clock intensity and the corresponding bias voltage and the initialization process is finished.

Subsequently, although the transfer function is drifted to ‘5B’ due to a change in the temperature during the operation of the optical transmitter, that the bias voltage is maintained without change causes the output optical signal is not optimized. That is, it is necessary to change the bias voltage adaptively according to the drift of the transfer function. This process is following. First, a direction has to be determined where the clock component is lower. Once a direction where the intensity of a clock component becomes lower is found by increasing or decreasing the initial optimum bias voltage, the control unit 14 commands moving a level of bias voltage toward the determined direction until a level of bias voltage at which the electric intensity becomes the same as the electric intensity at the initial bias voltage. Thus, to control the bias voltage adaptively can prevent an output optical signal from distortion due to the drift of the transfer function in the electro-optic modulator 12.

The method of the present invention can be embodied as a program and saved in a computer-readable recording medium such as CD-ROM, RAM, ROM, floppy disks, hard disks, magneto-optical disks and the like.

The technology of the present invention can improve and stabilize the performance of the entire optical communication system by establishing and maintaining the optimum bias voltage of the electro-optic modulator

Since the bias voltage at a point where the lowest electric intensity of a clock component can be established as the optimum bias voltage, the time for initialization can be reduced comparing to do full sweep in order to find the highest and the lowest and although the characteristics of the transfer function of the electro-optic modulator are drifted according to temperature, optimum signals can be outputted adaptively.

In comparison with the first reference, the bias voltage optimizing apparatus of the present invention can be formed without an additional signal generator and no signal that can be a source of noise is added to data signals. In comparison with the second reference, the bias voltage can be optimized without an additional signal generator and the maximum extinction ratio (ER) can be maintained after initialization and the bias voltage can be stabilized.

While the present invention has been described with respect to certain preferred embodiments, it will be apparent to those skilled in the art that various changes and modifications may be made without departing from the scope of the invention as defined in the following claims.

1. An apparatus for optimizing a bias voltage of an electro-optic modulator in an optical transmission system, comprising:
a clock component extracting means for extracting a clock frequency component from the frequency components in a wideband spectrum of the electro-optic modulator;
a bias voltage controlling means for finding a point of the lowest clock intensity by detecting electric intensities of the extracted frequency component from an output optical signal and maintaining the optimum output signal adaptively by changing the bias voltage; and
a bias voltage adjusting means for controlling the bias voltage of the electro-optic modulator under the control of the bias voltage controlling means.

2. The apparatus as recited in claim 1, wherein the clock component extracting means converts part of the frequency components in the wideband spectrum of an optical signal outputted from the electro-optic modulator into electric signals and extracts only the clock frequency components from the frequency components of the electric signals obtained from the optical-to-electrical conversion.

3. The apparatus as recited in claim 1, wherein the bias voltage controlling means detects an electric intensity of the clock frequency component extracted in the clock component extracting means, stores a point of the lowest electric intensity, compares the electric intensity of the currently extracted clock frequency component with the electric intensity at the point of the lowest electric intensity, and adaptively controls the bias voltage of the electro-optic modulator by utilizing the bias voltage adjusting means to be the point of the lowest electric intensity.

4. The apparatus as recited in claim 3, wherein the electro-optic modulator shows the optimum output characteristics at a point of the lowest electric intensity of the clock frequency component of an output signal when the bias voltage is changed according to the characteristics of a transfer function.

5. An optical transmitting system for converting an input electric signal into an optical signal in an electro-optic modulator and outputting the optical signal, comprising:
a light source for providing an optical signal of a predetermined intensity to the electro-optic modulator;
an electric signal amplifying means for amplifying the input electric signal and providing the amplified electric signal to the electro-optic modulator;
the electro-optic modulator for converting the electric signal into the optical signal and outputting the optical signal;
a clock component extracting means for extracting a clock frequency component from frequency components in a wideband spectrum of the electro-optic modulator;
a bias voltage controlling means for finding a point of the lowest electric intensity by detecting an electric intensity of the extracted clock frequency component and adaptively controlling the bias voltage so that the electric intensity of the currently detected electric signal to be the point of the lowest electric intensity by changing the bias voltage; and
a bias voltage adjusting means for adjusting the bias voltage of the electro-optic modulator under the control of the bias voltage controlling means.

6. The system as recited in claim 5, wherein the bias voltage controlling means finds out a direction where the electric intensity of a clock frequency component is decreased by increasing or decreasing the initial optimum bias voltage step by step and then detects a point where the electric intensity of the clock component becomes the same as the electric intensity of the clock component at the initial optimum bias voltage.

7. A method for optimizing bias voltage of an electro-optic modulator in an optical transmitting system, comprising the steps of:
a) extracting a clock frequency component from various frequency components in an output spectrum of the electro-optic modulator by supplying an arbitrary level of bias voltage to the electro-optic modulator;
b) comparing the electric intensity of a clock frequency component detected by supplying a bias voltage lower than a previous bias voltage with an electric intensity of a clock frequency component stored already;
c) storing only electric intensities of currently detected clock frequency component that are lower than the electric intensity of the previously stored clock frequency component and determining a point of the lowest electric intensity of a clock frequency component; and
d) adjusting the bias voltage of the electro-optic modulator to an optimum bias voltage when a transfer function is drifted due to a change in temperature during the operation of optical transmitter.

8. The system as recited in claim 7, wherein, in the step a), part of the frequency components in the wideband spectrum of an optical signal outputted from the electro-optic modulator is converted into electric signals and only a clock frequency component is extracted from the frequency components of the electric signals obtained from the conversion.

9. The system as recited in claim 7, wherein the optimum bias voltage is a point of the lowest electric intensity of a clock frequency component having an excellent eye opening of an output optical signal when the bias voltage is changed.
